(19) United States
(12) Patent Application Publication
(10) Pub. No.: US 2021/0005975 A1
(43) Pub. Date: Jan. 7, 2021

(54) PENTAGONAL SLOT BASED MIMO ANTENNA SYSTEM

(71) Applicant: King Fahd University of Petroleum and Minerals, Dhahran (SA)

(72) Inventors: Rifaqat Hussain, Dhahran (SA); Muhammad Umar Khan, Dhahran (SA); Mohammad Said Sharawi, Dhahran (SA)

(73) Assignee: King Fahd University of Petroleum and Minerals, Dhahran (SA)

(21) Appl. No.: 16/460,797

(22) Filed: Jul. 2, 2019

(51) Int. Cl. H01Q 21/00; H01Q 21/06; H01Q 1/38; H04B 7/0413

(52) U.S. Cl. CPC H01Q 21/005; H04B 7/0413; H01Q 1/38; H01Q 21/061

(57) ABSTRACT

An antenna system can include a dielectric substrate having a top surface and a bottom surface that is covered by a ground plane. Four identical antenna elements can be disposed on the bottom surface. Each antenna element can be formed by a pentagonal slot that is etched out of the ground plane. The four antenna elements are positioned symmetrically such that a layout of the four antenna elements has left-right symmetry and top-bottom symmetry. The dielectric substrate can be rectangular, and each pentagonal slot can have a side that is parallel with a longer edge of the dielectric substrate without a center of the pentagonal slots positioned between the side and the longer edge. The antenna system can further include a varactor diode for each of the four antenna elements. A capacitance of the varactor diode is loaded across the respective pentagonal slot.

### BACKGROUND

### Field of the Disclosure

The disclosure relates to reconfigurable multiple-input multiple-output (MIMO) antenna systems for compact wireless devices.

### Description of the Related Art

Modern wireless communication systems are always evolving to be able to provide higher data rates to mobile users. New features and services are continuously added to wireless handheld devices that operate across multiple wireless communication standards. Increased number of users results in frequency spectrum congestion. Requirements such as high data rates, supporting multiple wireless communication standards, and efficient utilization of spectrum resources can be satisfied by employing frequency reconfigurable multiple-input-multiple-output (MIMO) antenna systems in combination with cognitive radio (CR) techniques.

Descriptions of CR techniques can be found in the works of V. Valenta, R. Marlek, G. Baudoin, M. Villegas, M. Suarez, and F. Robert, “Survey on spectrum utilization in Europe: Measurements, analyses and observations,” Cognitive Radio Oriented Wireless Networks & Communications (CROWNCOM), 2010 Proc. Fifth Int. Conf. IEEE, vol. 92, pp. 1-5; and J. Mitola, “Cognitive radio architecture evolution,” Proc. IEEE, vol. 97, pp. 626-641, 2009, both of which are incorporated by reference in their entirety.

A CR system can change its operating band to avoid spectrum congestion. For example, a CR system senses a radio frequency (RF) spectrum using an ultra-wide-band (UWB) sensing antenna. When a spectrum hole is found, the CR system can allocate the available spectrum to a user for communication. An adaptive CR front-end is needed to interact dynamically with an RF spectrum and provide efficient channel allocation. The CR front-end can include a frequency reconfigurable antenna, such as a reconfigurable MIMO antenna system, which can change the resonance frequency as required.

Several frequency reconfigurable antennas are reported in the literature. In the work of X. Yang, J. Lin, G. Chen, and F. Kong, “Frequency reconfigurable antenna for wireless communications using GaAs FET switch,” IEEE Antennas and Wireless Propagation Letters, vol. 14, pp. 807-810, 2015, which is incorporated by reference in its entirety, a frequency reconfigurable antenna is presented based on transistor switching. The antenna covers 3 different bands: WLAN (2.4-2.48 GHz), WiMAX (2.5-2.69 GHz, 3.4-3.69 GHz) and PCS (1.85-1.99 GHz) with substrate dimensions of 30×30×1.524 mm.

In the work of T. Li, H. Zhai, X. Wang, L. Li, and C. Liang, “Frequency-reconfigurable bow-tie antenna for bluetooth, wimax, and wlan applications,” IEEE Antennas and Wireless Propagation Letters, vol. 14, pp. 171-174, 2015, which is incorporated by reference in its entirety, a PIN diode based frequency agile antenna is presented for Bluetooth, WiMAX, and WLAN applications. The antenna covers 2.2-2.53 GHz, 2.97-3.71 GHz and 4.51-6 GHz bands with a substrate area of 45×50 mm.

In the work of M. Borhani, P. Rezaei, and A. Valizade, “Design of a reconfigurable miniaturized microstrip antenna for switchable multiband systems,” IEEE Antennas and Wireless Propagation Letters, vol. 15, pp. 822-825, 2016, which is incorporated by reference in its entirety, a PIN diode based frequency reconfigurable microstrip square slot antenna is presented with an antenna size of 20×20×0.8 mm. The frequency agile antenna covers the frequency bands 2.3-2.51 GHz, 3.35-3.75 GHz, and 4.95-5.53 GHz for Bluetooth, WiMAX and WLAN, respectively.

In the work of G. Augustin, B. P. Chacko, and T. A. Denidni, “Electronically reconfigurable Uni-planar antenna for cognitive radio applications,” IET Microwave, Antennas and Propagation, vol. 8, no. 5, pp. 367-376, 2014, which is incorporated by reference in its entirety, a planar frequency reconfigurable antenna is presented covering the bands 1.6-6.0 GHz and 3.39-3.80 GHz. The dimensions of the substrate used are 120×103 mm2. A PIN diode controlled band-pass structure is integrated with the antenna to realize frequency reconfigurability.

In the work of L. Han, C. Wang, X. C and W. Zhnag, “Compact Frequency-Reconfigurable Slot Antenna for Wireless Applications,” IEEE Antennas and Wireless Propagation Letters, vol. 15, pp. 1795-1798, 2016, which is incorporated by reference in its entirety, a compact frequency reconfigurable slot antenna is presented. The bands covered by the antenna are 2.3 GHz, 4.5 GHz and WLAN 5.8 GHz with a substrate size of 27×25×0.8 mm. PIN diodes are integrated inside the slots to switch the resonance frequency of the antenna between single-band mode (LTE and WLAN) and two-band mode (LTE, AMT fixed service and WLAN).

MIMO antennas are commonly used to meet the high data rate requirements in current wireless systems. MIMO frequency reconfigurable antennas are desirable in CR applications. Some MIMO antennas are presented in the literature.

In the work of J.-H. Lim, Z.-J. Jin, C.-W. Song, and T.-Y. Yun, “Simultaneous frequency and isolation reconfigurable mimo pifa using pin diodes,” IEEE Transactions on Antennas and Propagation, vol. 60, no. 12, pp. 5939-5946, 2012, which is incorporated by reference in its entirety, a 2-element frequency reconfigurable MIMO antenna is presented with a substrate area of 90×50 mm. The antenna covers three m-WiMAX bands 2.3-2.4 GHz, 2.5-2.7 GHz and 3.4-3.6 GHz. PIN diodes are used to achieve frequency reconfigurability.

In the work of A. Raza, M. U. Khan and F. A. Tahir, “A Frequency Reconfigurable MIMO Antenna System for Cognitive Radio Applications,” Frequenz, Journal of RF-Engineering and Telecommunications, 2017, which is incorporated by reference in its entirety, a 2-element MIMO patch antenna is presented. A varactor diode based frequency agile antenna is tuned over the bands 2.12-2.32 GHz with a substrate area of 100×50 mm.

In the work of Cao Y., Cheung S. W., Yuk T. I.: “Frequency-reconfigurable multiple-input-multiple-output monopole antenna with wide-continuous tuning range”, IET Microwave Antennas & Propag., 2016, vol. 10, pp. 1322-1331, which is incorporated by reference in its entirety, a 2-element frequency reconfigurable monopole MIMO antenna is presented. The antenna covers WLAN (2.4-2.483 GHz and 5.15-5.35 GHz) and WiMAX (3.4-3.6 GHz) bands.

In the work of Jin Z. J., Lim J. H., Yun T. Y.: “Frequency reconfigurable multiple-input-multiple-output antenna with high isolation”, IET Microwave Antennas & Propag., 2012, vol. 6, pp. 1095-1101, which is incorporated by reference in its entirety, a 2-element PIN diode based frequency reconfigurable monopole MIMO antenna is presented. The antenna is tuned over the band 1.88-2.64 GHz with substrate dimensions of 49×55 mm.

In the work of B. Mun, C. Jung and M. -J. Park, “A Compact Frequency-Reconfigurable Multiband LTE MIMO Antenna for Laptop Applications,” IEEE Antennas and Wireless Propagation Letters, vol. 13, pp. 1389-1392, 2014, which is incorporated by reference in its entirety, a 2-element MIMO frequency agile antenna is presented with a total substrate size of 48.5×25 mm. The bands covered are WiMAX (3.36-3.7 GHz), WLAN (5-5.8 GHz) and WiMAX and WLAN (3.17-3.77 GHz and 5.13-5.88 GHz).

Descriptions of 4-element based MIMO antennas are presented in the literature. In the works of R. Hussain and M. S. Sharawi, “Planar four-element frequency agile MIMO antenna system with chassis mode reconfigurability,” Microwave and Optical Technology Letters, vol. 57, no. 8, pp. 1933-1938, 2015; and R. Hussain and M. S. Sharawi, “Planar meandered-F-shaped 4-element reconfigurable multiple-input-multiple-output antenna system with isolation enhancement for cognitive radio platforms,” IET Microwaves, Antennas and Propagation, vol. 10, no. 1, pp. 45-52, 2016, both of which are incorporated by reference in their entirety, the 4-element modified monopole based frequency agile meandered F-shaped MIMO antenna is tuned over various frequency bands between 0.7-3 GHz with substrate dimensions of 65×120×1.56 mm. Both PIN and varactor diodes are used to obtain the reconfigurability function.

In the work of S. Soltani, P. Lotfi and R. D. Murch, “A Port and Frequency Reconfigurable MIMO Slot Antenna for WLAN Applications,” IEEE Transactions on Antennas and Propagation, vol. 64, no. 4, pp. 1209-1217, 2016, which is incorporated by reference by its entirety, a compact 4-element frequency reconfigurable antenna is presented. Reconfigurability is achieved using microelectromechanical system (MEMS) switches. The antenna covers the bands 4.9-5.725 GHz, 2.4-2.5 GHz and 4.9-5.725 GHz. The board dimensions are 46×20×1.6 mm.

Accordingly, it is one objective of the present disclosure to provide a compact, reconfigurable MIMO antenna system that provides smooth variation of the resonance frequencies and is suitable to be used in wireless handheld devices and mobile terminals for cognitive radio (CR) applications.

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

### SUMMARY

The foregoing paragraphs have been provided by way of general introduction, and are not intended to limit the scope of the following claims. The described embodiments, together with further advantages, will be best understood by reference to the following detailed description taken in conjunction with the accompanying drawings.

Aspects of the disclosure provide an antenna system. The antenna system can include a dielectric substrate having a bottom surface that is covered by a ground plane, and a top surface. Four identical antenna elements can be disposed on the bottom surface. Each antenna element can be formed by a pentagonal slot that is etched out of the ground plane.

In one example, the four antenna elements are positioned symmetrically such that a layout of the four antenna elements has left-right symmetry and top-bottom symmetry. In one example, wherein the dielectric substrate is rectangular, and each pentagonal slot has a side that is parallel with a longer edge of the dielectric substrate without a center of the pentagonal slots positioned between the side and the longer edge.

In one example, the antenna system can further include a varactor diode for each of the four antenna elements, a capacitance of the varactor diode being loaded across the respective pentagonal slot. The varactor diode for each of the four antenna elements can be disposed across the respective pentagonal slot. The antenna system can further include a biasing circuit for each of the four antenna elements configured to provide a bias voltage to the respective varactor diode. The biasing circuit can be disposed on the top surface of the dielectric substrate.

In one example, the antenna system further includes two defected ground structures (DGS) each disposed between two neighboring antenna elements and etched out of the ground plane. Each of the two DGS can include two parallel slots extending away from a patch positioned at an edge of the dielectric substrate.

In one example, the antenna system can further include four microstrip feed lines on the top surface of the dielectric substrate each corresponding to one of the four antenna elements. Each of the four microstrip feed lines can extend from an edge of the dielectric substrate and reaches a position above an area within the respective diagonal slot.

In one example, the dielectric substrate is an FR-4 substrate with a dielectric constant of 4.4 and a loss tangent of 0.002. In one example, the dielectric substrate have a size of 60×120 mm2, and the four antenna elements are disposed within a half portion of the bottom surface adjacent to a shorter edge of the dielectric substrate. In one example, the dielectric substrate has a size of 60×60 mm2. In one example, each diagonal slot has a side length of 7.8 mm. In an example, a resonant frequency of the antenna system is configured to change over a frequency band from 3.2 GHz to 3.9 GHz with a minimum—6 dB bandwidth of 55 MHz.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1A is a top view of an example antenna system according to an embodiment of the disclosure;

FIG. 1B is a bottom view of the example antenna system according to the embodiment of the disclosure;

FIG. 2 shows an example varactor diode biasing circuit according to an embodiment of the disclosure;

FIG. 3A shows simulated reflection coefficients of the antenna system;

FIG. 3B shows measured reflection coefficients of the antenna system;

FIGS. 4A and 4B each show measured and simulated reflection coefficient curves corresponding to a certain capacitance value of a varactor diode;

FIG. 5A shows simulation results of worst-case isolation between Ant-1 and Ant-2 without a defected ground structure (DGS);

FIG. 5B shows simulation results of worst-case isolation between Ant-1 and Ant-2 with a DGS;

FIG. 5C shows measurement results of worst-case isolation between Ant-1 and Ant-2 with the DGS;

FIG. 6A shows simulation results of worst-case isolation between Ant-1 and Ant-3 without a DGS;

FIG. 6B shows simulation results of worst-case isolation between Ant-1 and Ant-3 with a DGS;

FIG. 6C shows measurement results of worst-case isolation between Ant-1 and Ant-3 with the DGS;

FIG. 7A shows simulation results of worst-case isolation between Ant-1 and Ant-4 without a DGS;

FIG. 7B shows simulation results of worst-case isolation between Ant-1 and Ant-4 with a DGS;

FIG. 7C shows measurement results of worst-case isolation between Ant-1 and Ant-4 with the DGS;

FIGS. 8A and 8B show surface current densities on bottom and top sides of a PCB board of the antenna system when no DGS slots are employed;

FIGS. 9A and 9B show surface current densities on bottom and top sides of the PCB board of the antenna system when DGS slots are employed; and

FIG. 10 shows a table of simulated and measured envelop correlation coefficient (ECC) values.

### DETAILED DESCRIPTION OF EMBODIMENTS

The description set forth below in connection with the appended drawings is intended as a description of various embodiments of the disclosed subject matter and is not necessarily intended to represent the only embodiment(s). In certain instances, the description includes specific details for the purpose of providing an understanding of the disclosed subject matter. However, it will be apparent to those skilled in the art that embodiments may be practiced without these specific details. In some instances, well-known structures and components may be shown in block diagram form in order to avoid obscuring the concepts of the disclosed subject matter.

Reference throughout the specification to “one embodiment” or “an embodiment” means that a particular feature, structure, characteristic, operation, or function described in connection with an embodiment is included in at least one embodiment of the disclosed subject matter. Thus, any appearance of the phrases “in one embodiment” or “in an embodiment” in the specification is not necessarily referring to the same embodiment. Further, the particular features, structures, characteristics, operations, or functions may be combined in any suitable manner in one or more embodiments. Further, it is intended that embodiments of the disclosed subject matter can and do cover modifications and variations of the described embodiments.

It must be noted that, as used in the specification and the appended claims, the singular forms “a,” “an,” and “the” include plural referents unless the context clearly dictates otherwise. That is, unless clearly specified otherwise, as used herein the words “a” and “an” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein, merely describe points of reference and do not necessarily limit embodiments of the disclosed subject matter to any particular orientation or configuration. Furthermore, terms such as “first,” “second,” “third,” etc., merely identify one of a number of portions, components, points of reference, operations and/or functions as described herein, and likewise do not necessarily limit embodiments of the disclosed subject matter to any particular configuration or orientation.

Embodiments of a miniaturized 4-element frequency reconfigurable multiple-input-multiple-output (MIMO) antenna system are described in this disclosure. The antenna system can include pentagonal slot based frequency reconfigurable antenna elements. Varactor diodes are used to vary the capacitive reactance loaded to each pentagonal slot. The antenna system can be tuned over a frequency band covering 3.2-3.9 GHz with minimum −10 dB operating bandwidth of 55 MHz (or 100 MHz for −6 dB bandwidth). The frequency band overlaps operating bands of several well-known wireless standards including WiMAX (3.4-3.6 GHz), TDD LTE (3.6-3.8 GHz), and Wi-Fi 802.11y (3.65-3.7 GHz), along with several other bands. The antenna system can be fabricated on a dielectric substrate, such as a commercially available FR-4 substrate with dimensions 60×120×1.56 mm, the substrate generally has a width of 10-100 mm, preferably 20-90 mm, 30-80 mm, 40-70 mm or 50-60 mm and a length of 20-150 mm, preferably 30-140 mm, 40-130 mm, 50-120 mm, 60-110 mm, 70-100 mm, or 80-90 mm. The substrate preferably has a thickness of 0.5-3 mm, preferably 0.75-2.5 mm, 1.0-2.0 mm or about 1.5 mm. The isolation between adjacent antenna elements is improved using slot-line based defected ground structures (DGS). The antenna system can maintain a minimum isolation of 10 dB in its entire covered operating bands. The antenna system is compact and planar in structure, and thus is suitable for wireless handheld devices and mobile terminals with cognitive radio (CR) capabilities. In alternative embodiments, the antenna system may include a different number (e.g., 3 or 5) of identical antenna elements.

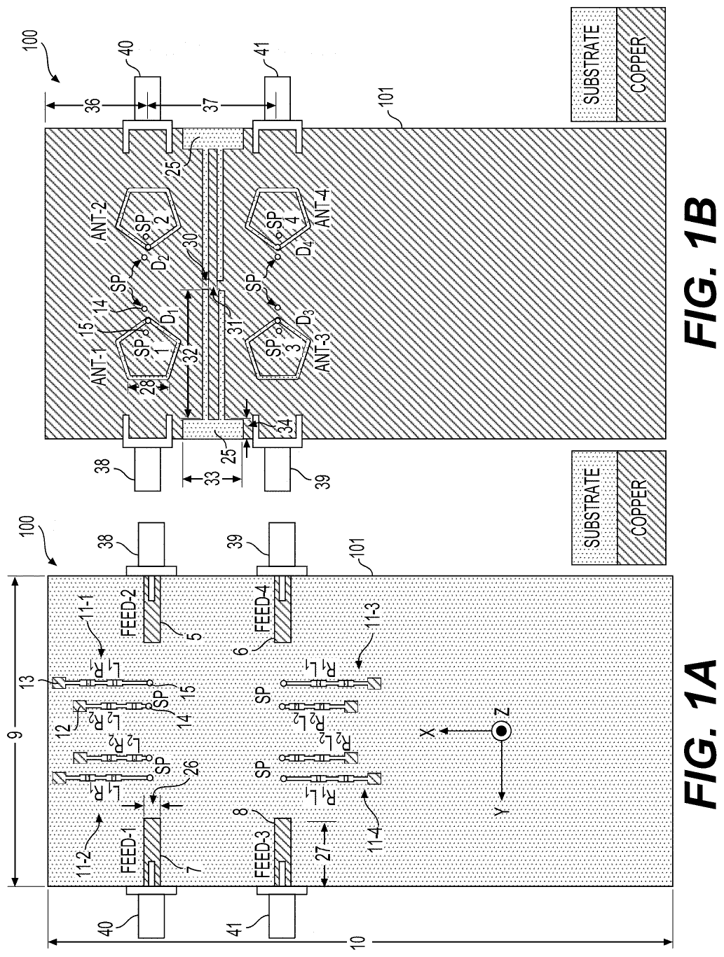

FIG. 1A and FIG. 1B are a top view and a bottom view, respectively, of an example antenna system 100 according to an embodiment of the disclosure. The antenna system 100 can be, for example, a 4-element pentagonal slot based frequency agile MIMO antenna system. The top view shows four sets of varactor diode biasing circuits 11-1, 11-2, 11-3, and 11-4, and feed lines (Feed-1 to Feed-4) 5-8 on a top surface of the antenna system 100. The feed lines 5-8 are connected to center conductors (center pins) of coaxial connectors 38-41, respectively. The bottom view shows four antenna elements (Ant-1, Ant-2, Ant-3, and Ant-4) 1-4 on a ground (GND) plane on a bottom surface of the antenna system 100. Outer conductors of the coaxial connectors 38-41 are in connection with the GND plane.

The antenna system 100 can be fabricated on a rectangular or square dielectric substrate 101, such as a commercially available FR-4 substrate. In one example, the antenna system 100 is fabricated using an LPKF S103 machine. In an example, the dielectric substrate 101 has a dielectric constant (or relative permittivity) (εr) of 4.4 and loss tangent of 0.002. In alternative examples, the dielectric substrate 101 may have different dielectric constant or loss tangent values. For example, the dielectric constant can range typically from 1 to 10, and preferably from 3 to 5.5. The loss tangent can range typically from 0.0005 to 0.009, and preferably from 0.001 to 0.005.

In one example, the rectangular dielectric substrate has a shorter edge 9 and a longer edge 10. In one example, the shorter edge 9 has a length of 60 mm, and the longer edge 10 has a length of 120 mm. In alternative examples, different ratios of shorter edge to longer edge may be adopted. In the example shown in FIGS. 1A and 1B, the four antenna elements 1-4 are intentionally disposed at an upper half portion of the PCB of the antenna system 100. The unoccupied space on the PCB can be used for accommodating other components on the PCB (e.g., electronics, battery, etc.) in various applications. The performance of the antenna system 100 can remain unaffected if the unoccupied space (the lower half portion of the PCB) is removed. As a result, the antenna system 100 can have a smaller size such as the size of the upper half portion of the dielectric substrate shown in FIGS. 1A and 1B.

In one example, the dielectric substrate has a thickness of 1.56 mm. In alternative examples, the thickness of the dielectric substrate can typically range from 0.3 mm to 3 mm, and preferably from 1 mm to 2 mm.

According to the disclosure, an open slot based antenna does not work with varactor diodes, as it is difficult to reactively load the open slot based antenna with varactor diodes. On the other hand, it is found that a closed slot based design responds well to reactive loading with a varactor diode. Therefore, a closed pentagonal slot-line based design is selected in various embodiments because of its good input impedance matching property, strong radiation characteristics, optimized area, and ease of reactive loading as compared to other open slot based designs.

For example, during the design process, each of the four antenna elements can first be designed with an open slot of length λ/2 with a substrate size of 120×60 mm. The objective is to design a 4-element MIMO antenna system with high MIMO performance and high isolation between respective elements. The open slot antenna elements can then be converted to a closed loop pentagonal slot-line to optimize the occupied area and make the antenna element responsive to reactive loading. The elements can each be excited using an open-ended microstrip feed line of 50Ω. The antenna elements initially resonate at 4.5 GHz. Each antenna element is optimized to operate at lower frequency bands by reactively loading the respective pentagonal slot using a varactor diode. Parametric sweeps can be performed to optimally place the varactor diodes on the slot peripheries. As a result, input impedance matching at lower frequency bands can be obtained, and miniaturization of the antenna system can be achieved. The isolation is enhanced between closely spaced antenna elements by using DGS formed by rectangular line slots within the GND plane. In addition, the DGS can also help to improve the input impedance matching at different reactive loading values.

As shown in FIG. 1B, the antenna system 100 includes the four identical antenna elements 1-4 that are etched out of the GND plane of the dielectric substrate 101 (e.g., a copper foil covering the bottom surface of the dielectric substrate 101). The four antenna elements 1-4 can be symmetrically disposed on the bottom surface of the dielectric substrate 101. For example, a layout of the four antenna elements 1-4 can be left-right symmetric and top-down symmetric. For example, the top two elements 1-2 are mirror images of the bottom two elements 3-4 while the left two elements 1 and 3 are mirror images of the right side two elements 2 and 4. As a result of the symmetrical arrangement, the antenna elements 1-4 can have similar frequency responses. In alternative examples, the four antenna elements 1-4 may be asymmetrically disposed.

In an example, centers of the upper two elements 1-2 are positioned at a distance 36 of 20 mm from the shorter edge 9, while centers of the lower two elements 3-4 are positioned at a distance 37 of 25 mm from the two centers of the upper two elements 1-2.

Each antenna element 1-4 can be formed by a pentagonal-shaped radiation slot. In one example, a length 28 of each side of the pentagonal slots is 7.8 mm. In an example, the antenna elements 1-4 are arranged in a way that each antenna element 1-4 has a side parallel with the longer edge 10 of the dielectric substrate 101. In addition, in an example, in the horizontal direction, the side parallel with the longer edge 10 of each antenna element 1-4 is positioned opposite to the respective neighboring element with respect to the pentagonal slot center of this side. For example, in FIG. 1B, for the antenna element 1, the side parallel with the longer edge 10 is positioned between the longer edge and the center of the antenna element 1, and is opposite to the antenna element 2 with the center of the antenna element 1 in between.

The dimensions and placement of the pentagonal slots shown in FIGS. 1A and 1B are optimized to obtain an optimum performance. In alternative examples, the slots may have different dimensions. For example, corresponding to the size of 60 mm×120 mm of the substrate 101, the side length of the pentagonal slot 28 can range typically from 5 mm to 10 mm.

In one example, the centers of the antenna elements 1 and 2 are aligned with a line passing the center pins of the coaxial connectors 38 and 40, while the centers of the antenna elements 3 and 4 are aligned with a line passing center pins of the coaxial connectors 39 and 41. In alternative examples, the positions of each antenna element 1-4 with respect to the edges of the dielectric substrate 101 or the coaxial connectors 38-41 can be different from what is shown in FIGS. 1A-1B. For example, the distance 36 can be in a range from 15 mm to 25 mm.

As shown in FIGS. 1A-1B, for each antenna element 1-4, two shorting pins (SP) (or shorting vias) 14-15 are created through the substrate 101 for connecting respective antenna elements 1-4 with varactor diode biasing circuits 11-1 to 11-4. For example, as shown in FIG. 1B (bottom view), at the antenna element 1, a first shorting pin 14 is connected to the area outside of the pentagonal slot, and a second shorting pin 15 is connected to the area inside of the pentagonal slot. Thus, a first varactor diode D1 can be connected between the shorting pins 14 and 15 crossing the pentagonal slot of the antenna element 1. The first varactor diode D1 can be disposed on either side of the dielectric substrate 101 in various examples. For the elements 2-4, the varactor diode D2-D4 can similarly be disposed near the respective antenna element. In alternative examples, more than one varactor diode may be employed, for example, disposed on suitable positions for adding capacitance impedance to the pentagonal slot of each antenna element. Accordingly, shorting pins more than two can be positioned at suitable locations.

In addition, the shorting pins 14 are connected to a contact pad 12 via, for example, a resistor R2 and a inductor L2, while the second shorting pin 15 is connected to a contact pad 13 via, for example, a resistor R1 and a inductor L1. The resistors R1 and R2 and the inductors L1 and L2 form one of the varactor diode biasing circuits 11-1. For example, a variable voltage source can be connected between the contact pads 12 and 13 to adjust a capacitance of the varactor diode D1 to vary a capacitance impedance loaded to the antenna element 1. Consequently, a resonant frequency of the antenna element 1 can be changed. The varactor diode biasing circuits 11-2, 11-3, and 11-4 can be similarly configured as the varactor diode biasing circuits 11-1 to load capacitance impedance to the respective antenna elements 2-4.

In the example shown in FIG. 1B, the varactor diodes D1-D4 of each antenna elements are shown to be positioned across the respective pentagonal slots. However, in other examples, a varactor diode for loading one of the four antenna elements may be disposed in any other suitable locations, and can be connected to the respective shorting pins via conductive media, such as copper lines, microstrips, and the like. In addition, the shorting pins may be positioned at locations different from what is shown in FIG. 1A and FIG. 1 B in some examples.

As shown in FIG. 1A, in one example, the four coaxial connectors 38-41 (e.g., subminiature version A connectors) are disposed on the longer edges of the dielectric substrate 101. The microstrip feed lines 5, 6, 7, 8 in FIG. 1A are disposed on the top surface of the antenna system 100, and connected with center pins of the respective coaxial connectors 38-41 to feed the four antenna elements 1-4. Each microstrip feed line 5-8 can extend from the left or right edge to a position above the area inside of the pentagonal slot at each antenna element 1-4. In some examples, each microstrip feed line 5-8 can be identical, and having a length 27 of 13 mm and a width of 1.3 mm. In one example, a distance 37 between the center pins of the coaxial connectors 38 and 39, or 40 and 41 is 25 mm. In other examples, the feed line 5-8 may have different shapes and sizes.

As shown in FIG. 1B, in one example, a DGS 25 is introduced between two vertically adjacent antenna elements 1 and 2, or 3 and 4, to isolate a mutual coupling between the two adjacent antenna elements. The dimensions of each DGS 25 are given as 30 (1 mm), 31 (2 mm), 32 (25 mm), 33 (12 mm), 34 (4 mm) in one example. In alternative example, the DGS 25 may have different structures. In one example, as shown in FIG. 1B, the DGS 25 can include two parallel slots extending from a patch adjacent to the longer edge 10 of the dielectric substrate 101. The patch and the two parallel slots can be etched out of the ground plane. In one example, there is different number of slots extending from the respective longer edge 10. In one example, the slots extending from the longer edge 10 can have different shapes other than what is shown in FIG. 1B.

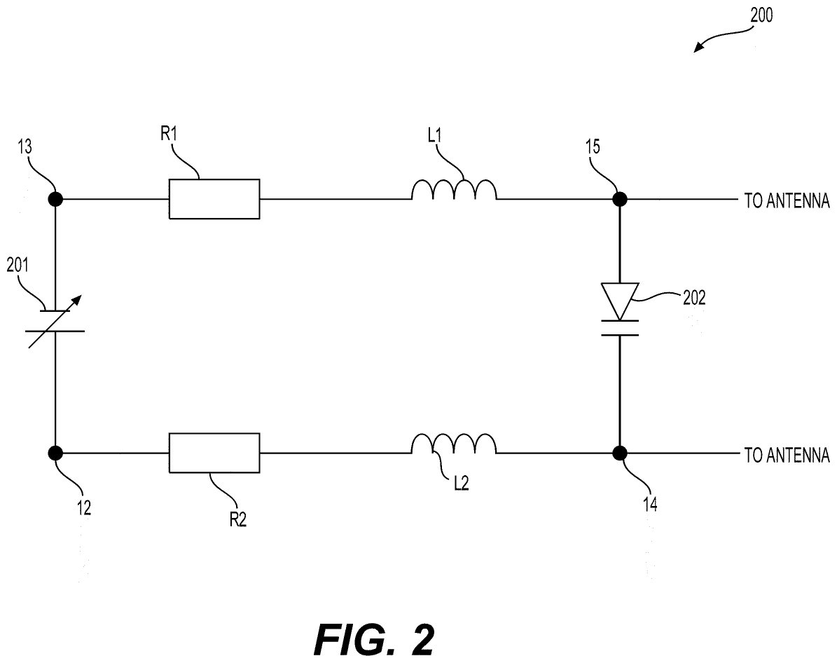

FIG. 2 shows an example varactor diode biasing circuit 200 according to an embodiment of the disclosure. As shown, the resistor R1 and the inductor L1 are connected between the contact pad 13 and the shorting pin 15. The resistor R2 and the inductor L2 are connected between the contact pad 12 and the shorting pin 14. A variable voltage source 201 is connected between the contact pads 12 and 13. A varactor diode 202 is connected between the shorting pins 15 and 14, and is reverse biased by the biasing circuit 200. By varying the voltage source 201, a reverse bias voltage on the varactor diode 202 can be varied. Accordingly, a capacitance of the varactor diode 202 can be adjusted to change a capacitance impedance loaded to one of the antenna elements 1-4.

In one example, the biasing circuits 200 can similarly be used for biasing the varactor diodes D1-D4 associated with each antenna elements 1-4. The variable voltage 210 can be applied to the 4 antenna elements 1-4 simultaneously. When varying the variable voltage 210, a resonant frequency of the antenna system 100 can be accordingly changed. In one example, the inductor L1 or L2 has an inductance of 1 μH, and the resistor R1 or R2 has a resistance of 2.1 kΩ. In one example, the varactor diodes D1-D4 are SMV 1233 varactor diodes.

Measurement Results

The frequency reconfigurable MIMO antenna system 100 as shown in FIG. 1 is modeled using HFSS™ simulation software. The antenna system 100 is designed by performing parametric sweeps over several variables such as width and radius of the pentagonal slots, varactor diode positions, and distances between vertically adjacent antenna elements. Port parameters (or S-parameters) of the fabricated antenna system 100 are measured using an Agilent™ N9918A vector network analyzer (VNA).

A. S-Parameters

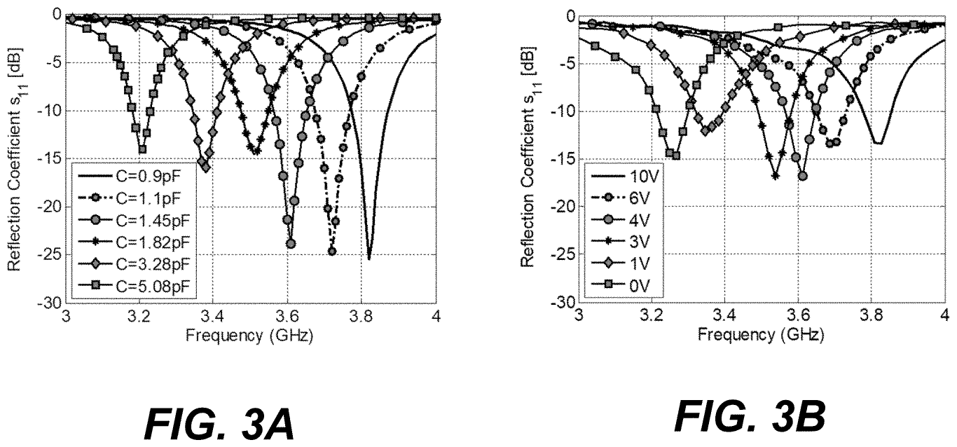

S-parameters of the fabricated antenna system 100 are measured while varying the reverse voltage applied across the varactor diodes D1-D4. The same procedure is carried out with the simulation software, where an equivalent lumped circuit for each varactor diode is used. Each varactor diode is modeled as a variable capacitor and the capacitive values used are changed according the datasheet of the varactor diode. The simulated and measured reflection coefficients (S11 parameter) of the optimized design of Ant-1 are shown in FIG. 3A and FIG. 3B, respectively. Since all antenna elements are similar to each other in structure, similar behaviors are observed for other antennas Ant-2, Ant-3, and Ant-4.

As shown, the measured and simulated reflection coefficient curves closely agree with each other. Slight shifts between the simulated and measured values are observed because of the basing circuit and fabrication tolerances. As the value of the biasing voltage increases (e.g., from 0 V to 10 V), the value of the capacitance across the varactor diode decreases (e.g., from 5.08 pF to 0.9 pF) and operating frequency of the antenna system 100 shifts from left to right towards higher values. The varactor diode provides a capacitance of 5.08 pF when no voltage is applied across its terminals. At 0 V, the antenna element Ant-1 resonates at 3.2 GHz. By increasing the value of the reverse bias voltage across varactor diode, a smooth frequency sweep is observed. At 10V, the varactor diode provided a capacitance of 0.9 pF and the antenna element Ant-1 resonates at 3.9 GHz. Further increase in reverse bias voltage across the varactor diode does not significantly change the resonance frequency. Hence, by varying the voltage across the diode from 0V to 10V, the antenna system 100 is tuned over a frequency band between 3.2 GHz to 3.9 GHz with a minimum −10 dB bandwidth of 55 MHz (and a −6 dB bandwidth of 100 MHz).

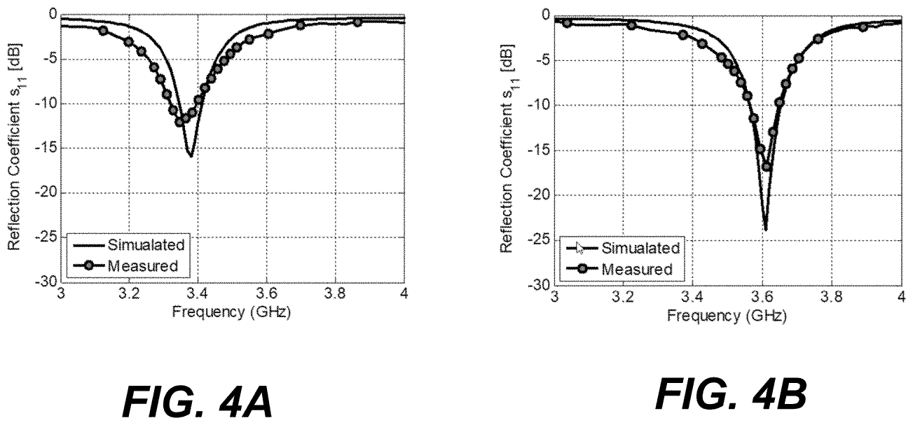

FIG. 4A and FIG. 4B further demonstrate the agreement between simulated and measured results. FIG. 4A shows measured and simulated reflection coefficient (S11) curves corresponding to a capacitance value of 3.28 pF, and an applied biasing voltage of 1 V. FIG. 4B shows measured and simulated reflection coefficient (S11) curves corresponding to a capacitance value of 1.45 pF, and an applied biasing voltage of 4 V. As shown, the simulated and measured results are in high agreement, and high level input impedance matching is achieved.

Isolation is an important parameter in MIMO antennas systems. Higher isolation values lead to higher efficiencies, and thus resulting in higher performance in a MIMO antenna system. Simulation and measurement results of isolation between adjacent antenna elements are shown in the following figures.

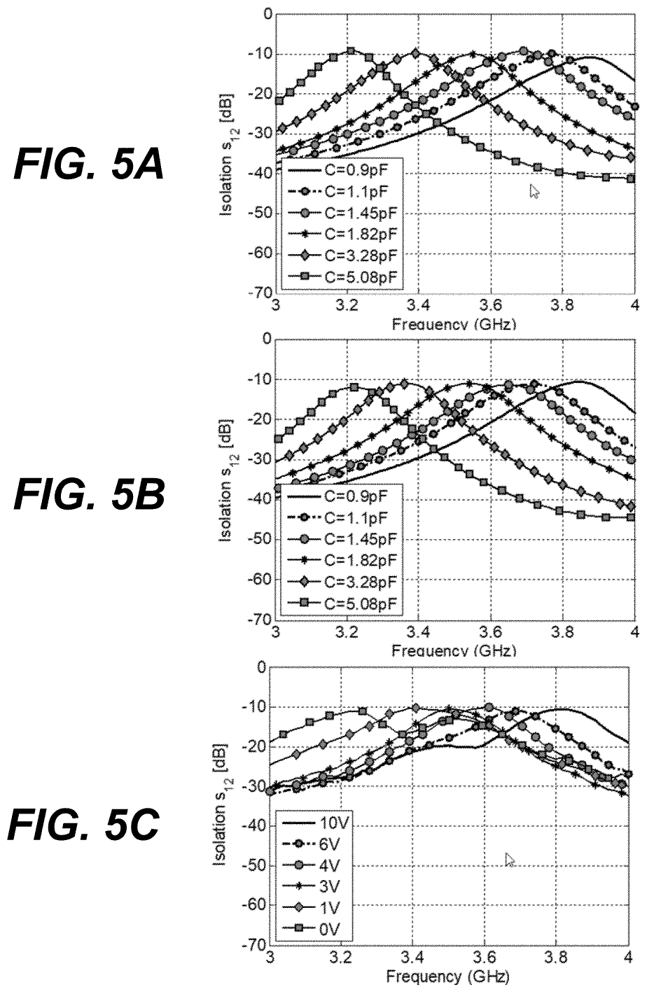

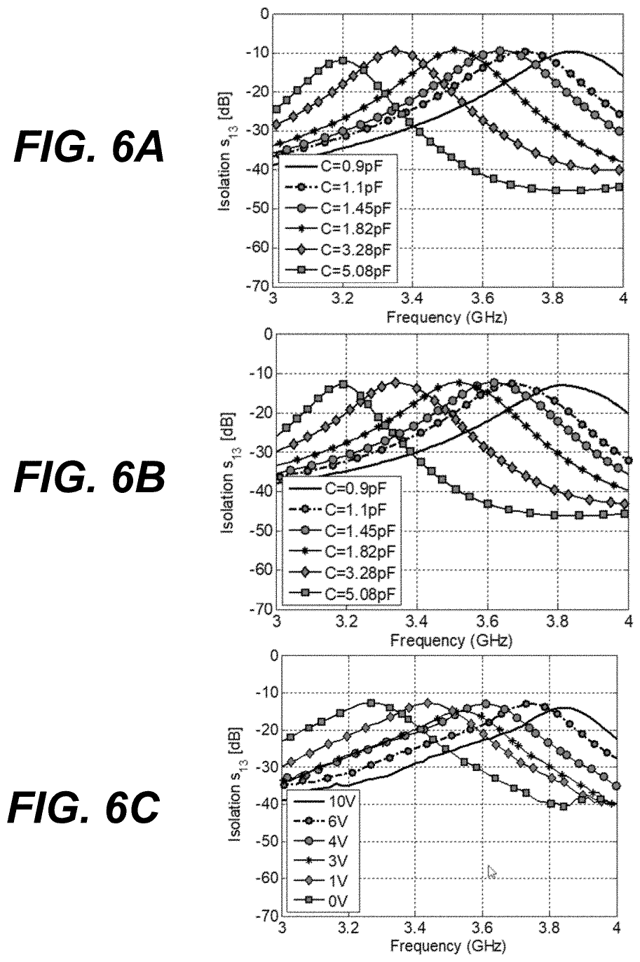

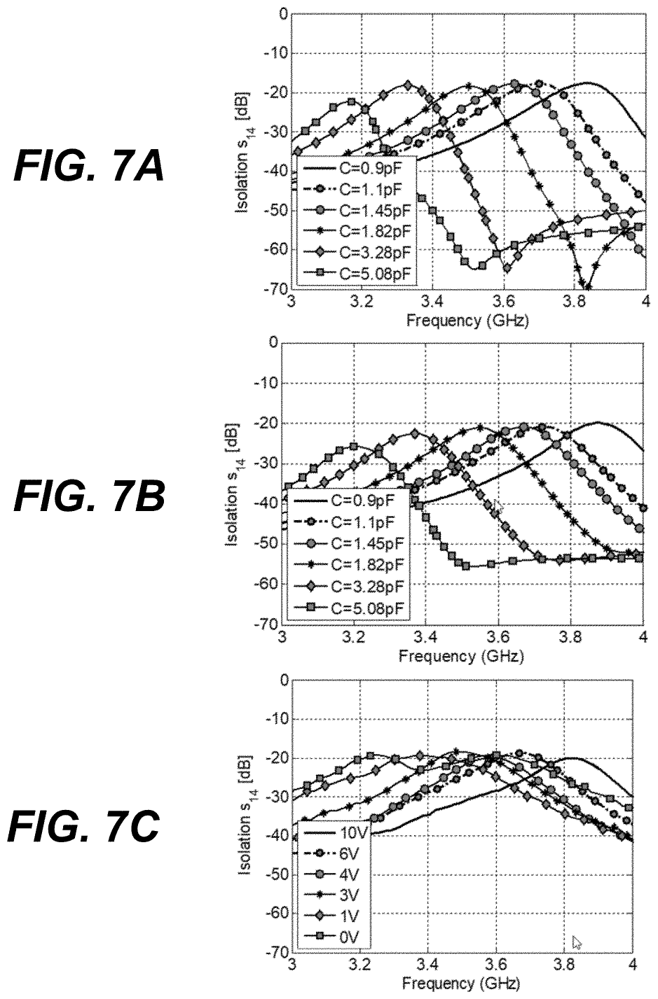

FIG. 5A shows simulation results of worst-case isolation between Ant-1 and Ant-2 without the DGS. FIG. 5B shows simulation results of worst-case isolation between Ant-1 and Ant-2 with the DGS. FIG. 5C shows measurement results of worst-case isolation between Ant-1 and Ant-2 with the DGS. FIG. 6A shows simulation results of worst-case isolation between Ant-1 and Ant-3 without the DGS. FIG. 6B shows simulation results of worst-case isolation between Ant-1 and Ant-3 with the DGS. FIG. 6C shows measurement results of worst-case isolation between Ant-1 and Ant-3 with the DGS. FIG. 7A shows simulation results of worst-case isolation between Ant-1 and Ant-4 without the DGS. FIG. 7B shows simulation results of worst-case isolation between Ant-1 and Ant-4 with the DGS. FIG. 7C shows measurement results of worst-case isolation between Ant-1 and Ant-4 with the DGS. As shown, isolation between neighboring antenna elements is improved when the DGS slots are employed. A minimum of 10 dB isolation between adjacent elements is observed over all frequency bands for various capacitance values.

B. Current Density

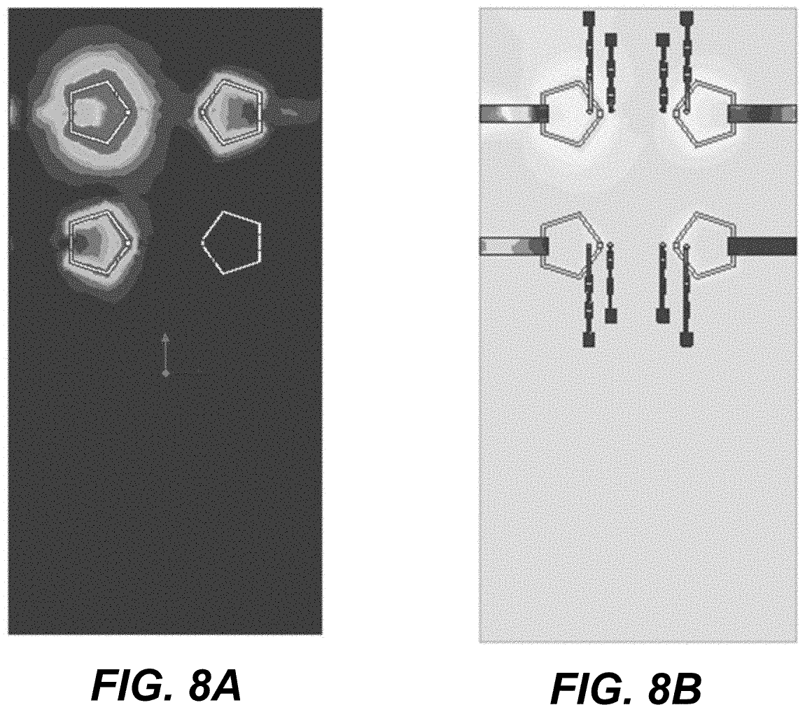

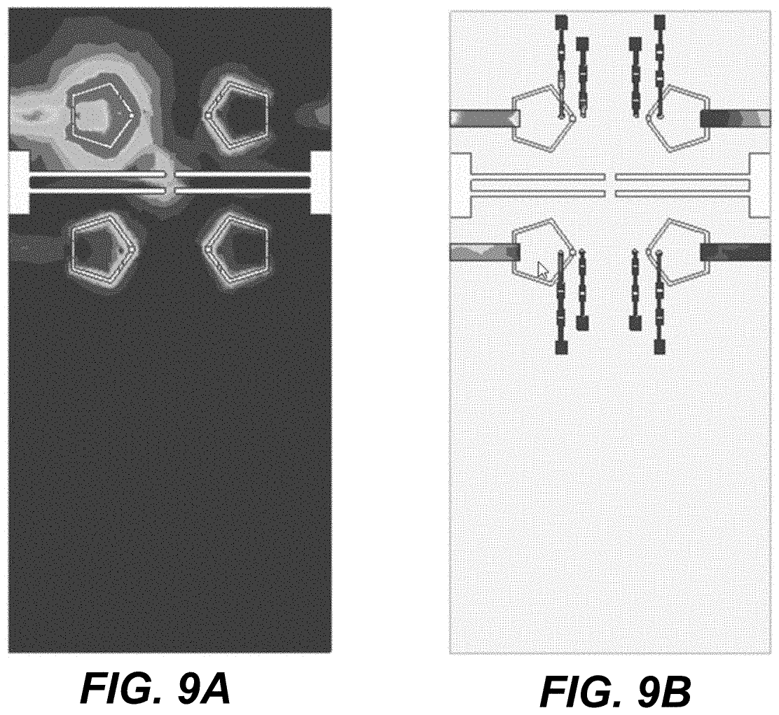

For the MIMO antenna system 100, surface current distributions are analyzed at 3.6 GHz (varactor diode capacitance 1.45 pF) with and without the DGS structure. The analysis identifies port coupling levels and locations of maximum concentration of the surface current density. The analysis illustrates the efficiency of slot based radiating structures. FIGS. 8A/8B/9A/9B show surface current density obtained at 3.6 GHz for the antenna element Ant-1 while the rest ports are terminated with 50Ω impedance. FIG. 8A and FIG. 8B show the surface current densities on the bottom and top sides of the PCB board of the antenna system 100 when no DGS slots are employed. In contrast, FIG. 9A and FIG. 9B show the surface current densities on the bottom and top sides of the PCB board of the antenna system 100 when DGS slots are employed.

As shown, when no DGS slots are employed (FIGS. 8A and 8B), high level surface current appears around Ant-1 pentagonal slot, and considerable coupling current exists between Ant-1 and Ant-3, and between Ant-1 and Ant-2. However, Ant-4 is well isolated from the rest of the antenna ports. In contrast, when DGS slots are employed (FIGS. 9A and 9B), high density surface current appears in the vicinity of Ant-1 pentagonal slot on the GND plane, while the antenna elements Ant-2, Ant-3, and Ant-4 are well isolated from the radiating structure of Ant-1. Thus, the DGS slots are effective to reduce mutual coupling between closely spaced antenna elements.

In addition, the surface current distributions shown in FIG. 8A or FIG. 9A also demonstrate the high efficiency of pentagonal slot based antennas. As shown, the GND plane of the slot based antenna is excited to function as a radiator. The energy from the feedline is coupled to the pentagonal slot as well as to the GND plane. Thus, the input energy is not only radiated from the vicinity of the respective slot but also through the GND plane. Thus, the radiation from the GND plane helps to improve the overall radiation efficiency of the pentagonal slot based antenna system.

C. Radiation Characteristics

Three-dimensional (3-D) gain patterns of the antenna system 100 are obtained from the HFSS simulation software. The simulated 3D radiation patterns at 3.3 GHz and 3.6 GHz are obtained and analyzed. Peak gain values are also measured for the antenna system 100. The frequencies (fm) used for the measurement are (3.24 GHz, 3.42 GHz, 3.52 GHz, 3.61 GHz, 3.71 GHz and 3.84 GHz) with corresponding peak gains and antenna efficiency (%η) values given as (2.2, 3.75, 3.95, 4.1, 4.5, and 4.65), and (59%, 65%, 71%, 74%, 77%, and 80%), respectively. In the simulated 3D radiation patterns, the maxima of the radiation patterns of Ant-1 and Ant-2 are in opposite directions, which lead to low envelop correlation coefficient (ECC) values.

According to the disclosure, ECC and isolation values between closely spaced antenna elements are two important parameters used to properly characterize MIMO antenna systems. ECC is a measure of how adjacent antenna elements are correlated with each other. Ideally, high isolation and low ECC are required as discussed in the work of M. S. Sharawi, “Printed MIMO antenna engineering,” Artech House, 2014, which is incorporated by reference in its entirety. However, the earlier used method to find ECC using the S-parameters has been found to have limited validity under limited conditions, as discussed in the work of M. S. Sharawi, “Current Misuses and Future Prospects of Printed Multiple-Input-Multiple-Output Antenna Systems,” IEEE Antennas and Propagation Magazine, Vol. 59, No. 2, pp. 162-170, 2017, which is incorporated by reference in its entirety. Therefore, ECC as a function of the individual complex radiation patterns of the antenna elements can be calculated using these patterns. For the antenna system 100, the ECC values obtained between all antenna elements are below the threshold value of 0.5 as described in the work of M. S. Sharawi, “Printed MIMO antenna engineering,” Artech House, 2014.

Further, the isolation between antenna elements of the antenna system 100 is at least 10 dB, which is adequate for the design of a MIMO antenna system according to the works of K. K. Kishor, and S. V. Hum. “A pattern reconfigurable chassis-mode MIMO antenna.” IEEE Transactions on Antennas and Propagation Vol. 62, No. pp. 3290-3298, 2014; R. Hussain, and M. S. Sharawi. “A cognitive radio reconfigurable MIMO and sensing antenna system”, IEEE Antennas and Wireless Propagation Letters, Vol. 14, pp. 257-260, 2015; and A. Cihangir, F. Ferrero, G. Jacquemod, P. Brachat, and C. Luxey, “Neutralized coupling elements for MIMO operation in 4G mobile terminals.” IEEE Antennas and wireless propagation letters, Vol. 13, pp. 141-144, 2014, which are incorporated herein by reference in their entirety.

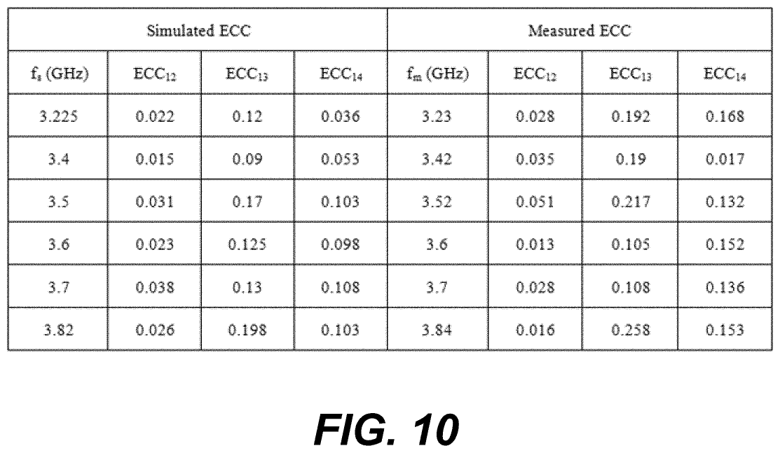

The simulated and measured ECC values are summarized in a table shown in FIG. 10. In the table, fs and fm represent operating frequencies of the antenna system 100 used in simulations and measurement, respectively.

According to the disclosure, in modern wireless communication system, MIMO antenna systems are highly desirable to meet high date rate and reliable communication requirements. For example, MIMO antenna systems offer high quality of service (QoS) with increased spectral efficiency. MIMO antenna systems can be employed to obtain a wider coverage compared with single element antenna systems. The 4-element antenna system disclosed herein can fulfill functions of a MIMO antenna system, and provide advantages lacked in a single element antenna system.

In single element antenna design, isolation/mutual coupling is irrelevant, while in 4-element antenna design, it is important to consider the mutual coupling between closely spaced neighboring antenna elements. The neighboring antenna elements are preferably isolated to serve as different MIMO communication channels. Accordingly, the DGS 25 can be employed to reduce the mutual coupling between the two closely spaced antenna elements.

Additionally, in MIMO antenna design, it is important to place MIMO antenna elements to have a better-input impedance matching. Radiation patterns of neighboring antenna elements should ideally be orthogonal. Those requirements are not considered for a single element antenna. For example, in MIMO antenna design, MIMO performance metrics, such isolation, envelop correlation coefficient (ECC), and total active reflection coefficients (TARC), and the like, are analyzed and validated. However, analysis to those parameters is not required for single element antenna design.

In one embodiment the present disclosure provides a reconfigurable pentagonal slot-line based compact 4-element MIMO antenna. The design was realized on an FR-4 board of dimensions 60×120 mm and was compact with low profile that exhibited wide frequency tuning covering 3.2 GHz to 3.9 GHz. The MIMO antenna covered WiMAX (3.4-3.6 GHz) band, TDE LTE (3.6-3.8 GHz) and Wi-Fi 802.11y (3.65-3.7 GHz), along with several other wireless standard bands with a minimum bandwidth of 55 MHz. To improve the isolation between adjacent antenna elements, dual DGS slot-lines were utilized which considerably reduced the mutual coupling. Reconfigurability was achieved electronically using varactor diodes. The MIMO antenna was evaluated for MIMO parameters including ECC and TARC. Through detailed analysis, it was shown that the proposed MIMO antenna can be used within wireless handheld devices for WiMAX bands and CR applications.

Particular benefits and features of the present disclosure include:
1) The MIMO antenna introduces a pentagonal slot-based miniaturized frequency reconfigurable MIMO antenna suitable for Interweave CR applications.
2) The MIMO antenna includes or consists of 4 antenna elements that are etched out of the GND and accommodated on a small area on the top side of the PCB board.
3) The MIMO antenna provides a continuous frequency sweep over the bands 3.2 to 3.9 GHz with minimum −10 dB operating bandwidth of 55 MHz (100 MHz when considering the −6 dB bandwidth).
4) The MIMO antenna covers several standards including WiMAX (3.4-3.6 GHz) band, TDD LTE (3.6-3.8 GHz) and Wi-Fi 802.11y (3.65-3.7 GHz), LTE bands 42 (3.4-3.6 GHz), 43 (3.6-3.8 GHz) along with several others.
5) In addition, the MIMO antenna is miniaturized by capacitively loading the slot using single varactor diode per antenna element.
6) The MIMO antenna is suitable for WiMAX applications in wireless handheld devices for CR platforms.
7) The MIMO antenna has is a low profile planar structure that can be easily integrated with other circuit elements.
8) The MIMO antenna has a variable reactance for tunability over the wide-band is provided by a single varactor diode per antenna element.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. An antenna system, comprising:
a dielectric substrate having a bottom surface that is covered by a ground plane, and a top surface; and
four antenna elements on the bottom surface that are identical with each other, each antenna element being formed by a pentagonal slot that is etched out of the ground plane.

2. The antenna system of claim 1, wherein the four antenna elements are positioned symmetrically such that a layout of the four antenna elements has left-right symmetry and top-bottom symmetry.

3. The antenna system of claim 2, wherein the dielectric substrate is rectangular, and each pentagonal slot has a side that is parallel with a longer edge of the dielectric substrate without a center of the pentagonal slots positioned between the side and the longer edge.

4. The antenna system of claim 1, further comprising:
a varactor diode for each of the four antenna elements, a capacitance of the varactor diode being loaded across the respective pentagonal slot.

5. The antenna system of claim 4, wherein the varactor diode for each of the four antenna elements is disposed across the respective pentagonal slot.

6. The antenna system of claim 4, further comprising:
a biasing circuit for each of the four antenna elements configured to provide a bias voltage to the respective varactor diode.

7. The antenna system of claim 6, wherein the biasing circuit is disposed on the top surface of the dielectric substrate.

8. The antenna system of claim 1, further comprising:
two defected ground structures (DGS) each disposed between two neighboring antenna elements and etched out of the ground plane.

9. The antenna system of claim 9, wherein each of the two DGS comprises:
two parallel slots extending away from a patch positioned at an edge of the dielectric substrate.

10. The antenna system of claim 1, further comprising:
four microstrip feed lines on the top surface of the dielectric substrate each corresponding to one of the four antenna elements.

11. The antenna system of claim 10, wherein each of the four microstrip feed lines extends from an edge of the dielectric substrate and reaches a position above an area within the respective diagonal slot.

12. The antenna system of claim 1, wherein the dielectric substrate is an FR-4 substrate with a dielectric constant of 4.4 and a loss tangent of 0.002.

13. The antenna system of claim 1, wherein the dielectric substrate have a size of 60×120 mm², and the four antenna elements are disposed within a half portion of the bottom surface adjacent to a shorter edge of the dielectric substrate.

14. The antenna system of claim 1, wherein the dielectric substrate has a size of 60×60 mm².

15. The antenna system of claim 1, wherein each diagonal slot has a side length of 7.8 mm.

16. The antenna system of claim 1, wherein a resonant frequency of the antenna system is configured to change over a frequency band from 3.2 GHz to 3.9 GHz with a minimum—6 dB bandwidth of 55 MHz.

17. An antenna system, comprising:
a rectangular dielectric substrate having a bottom surface that is covered by a ground plane;
four identical antenna elements each having a structure of a pentagonal slot that is etched out of the ground plane; and
at least one varactor diode for each of the four antenna elements for loading a capacitance to each antenna element.

18. The antenna system of claim 17, further comprising:
two defected ground structures (DGS) each disposed between two antenna elements disposed along a longer edge of the dielectric substrate, and etched out of the ground plane.

19. The antenna system of claim 18, wherein one side of each pentagonal slot is parallel with the longer edge of the dielectric substrate with the one side disposed between the longer edge and a center of the respective pentagonal slot including the one side.

20. A frequency reconfigurable multiple-input-multiple-output (MIMO) antenna system comprising:
a first conductive layer and a second conductive layer attached to opposite sides of a substrate, wherein
the first conductive layer includes micro-strip feeding lines,
the second conductive layer includes four antenna elements that are symmetrically disposed on the second conductive layer,
each element is formed by a pentagonal radiating slot that is etched out of the second conductive layer, and
the second conductive layer further includes a pair of dual-slot-defected group structure (DGS) each inserted between two neighboring antenna elements; and
a varactor diode for each pentagonal radiating slot, wherein the varactor diode has a capacity loaded across the respective pentagonal radiating slot, and is controlled by a biasing circuitry to change a capacitive reactance of the respective pentagonal radiating slot.
